(19) United States
(12) Patent Application Publication
(10) Pub. No.: US 2003/0057147 A1
(43) Pub. Date: Mar. 27, 2003

(54) Filtration device and system for biological fluids

(75) Inventor: Peter C. Sutcliffe, Westford, MA (US)

Correspondence Address: Brett Hutton, Heslin Rothenberg Farley & Mesiti P.C., 5 Columbia Circle, Albany, NY, 12203, US

(73) Assignee: Hemasure, Inc., Marlborough, MA

(21) Appl. No.: 09/961,474

(22) Filed: Sep. 24, 2001

(51) Int. Cl. B01D 27/06

(52) U.S. Cl. 210/437; 210/767; 210/497.1

(57) ABSTRACT

A filtration system for the filtration of a biological fluid includes a filtration device interposed between a fluid supply source and a collection container. The filtration device includes a filtration assembly disposed within a housing. The housing has an inlet for receiving unfiltered fluid from the supply source and an outlet for exiting filtered fluid to the collection container. The filtration assembly includes a central core projecting into the housing and surrounded by filter material. The housing may be collapsible around the filter material to aid in the flow of the fluid and minimize hold-up fluid upstream of the filtration device.

### FIELD OF THE INVENTION

This invention relates generally to biological fluid filtration systems. More particularly, this invention relates to a non-vented, gravity driven biological fluid filtration device usable to filter biological fluid such as, for example, blood or blood components.

### BACKGROUND OF THE INVENTION

Various blood filtration devices exist in the prior art consisting of filters in a piled or stacked-up arrangement. Typically, unfiltered blood enters a top, flat portion of the stack-up arrangement and passes through to the bottom side of the stack where it is then collected in a collection container. However, these filtration devices are limited, because of size considerations, in the available filter surface area contacting the unfiltered blood. These types of filter arrangements also limit the amount of unfiltered blood passing through the filter of the filtration device at a particular time, which causes excessive hold-up volume of unfiltered blood. In order to provide more surface area for existing filtration devices, the top, flat portion of the device needs to be extended, causing the overall size of the device to increase.

Therefore, it is desirable to obtain a filtration device providing additional surface area while minimizing the impact on the overall size of the device to filter more blood. As will be described in greater detail hereinafter, the features of the present invention differs from those previously proposed.

### SUMMARY OF THE INVENTION

The shortcomings of the prior art may be alleviated and the aforementioned goals may be achieved by using a filtration system in accordance with one or more principles of the present invention. The filtration system of the present invention is useable when filtering blood or blood components to remove leukocytes, other blood components, cells, or chemical agents which may be used to treat the blood. Additionally, other uses may be made of the invention which fall within the scope of the claimed invention but which are not specifically described below.

In one aspect of the invention, there is provided a filtration device comprising a housing, a core and a filter. The housing includes an inlet for receiving unfiltered fluid and an outlet for exiting filtered fluid. The core is disposed within the housing. The core defines a flow path for delivering filtered fluid to the outlet of the housing. The core includes a closed first end projecting into the housing and a second end communicating with the outlet of the housing. The filter surrounds the core and filters the unfiltered fluid entering the inlet of the housing. The core receives the filtered fluid passing through the filter. In another aspect of the invention there is provided a filtration system comprising a supply source of unfiltered fluid, a collection container of filtered fluid, and a filtration device. The filtration device comprises a housing and a filtration assembly disposed within the housing. The housing includes an inlet for receiving unfiltered fluid from the supply source and an outlet for exiting filtered fluid to the collection container. The filtration assembly includes a filter material wrapped around a core. The core receives filtered fluid from the filter material and delivers the filtered fluid to the outlet of the housing.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a perspective view of one embodiment of a filtration system of the present invention.

FIG. 2 is a cross sectional view of one embodiment of a filtration device used in the filtration system in FIG. 1.

FIG. 3 is a cross sectional view taken along the line 3-3 of the filtration device shown in FIG. 2.

### DETAILED DESCRIPTION OF PREFERRED EMBODIMENTS

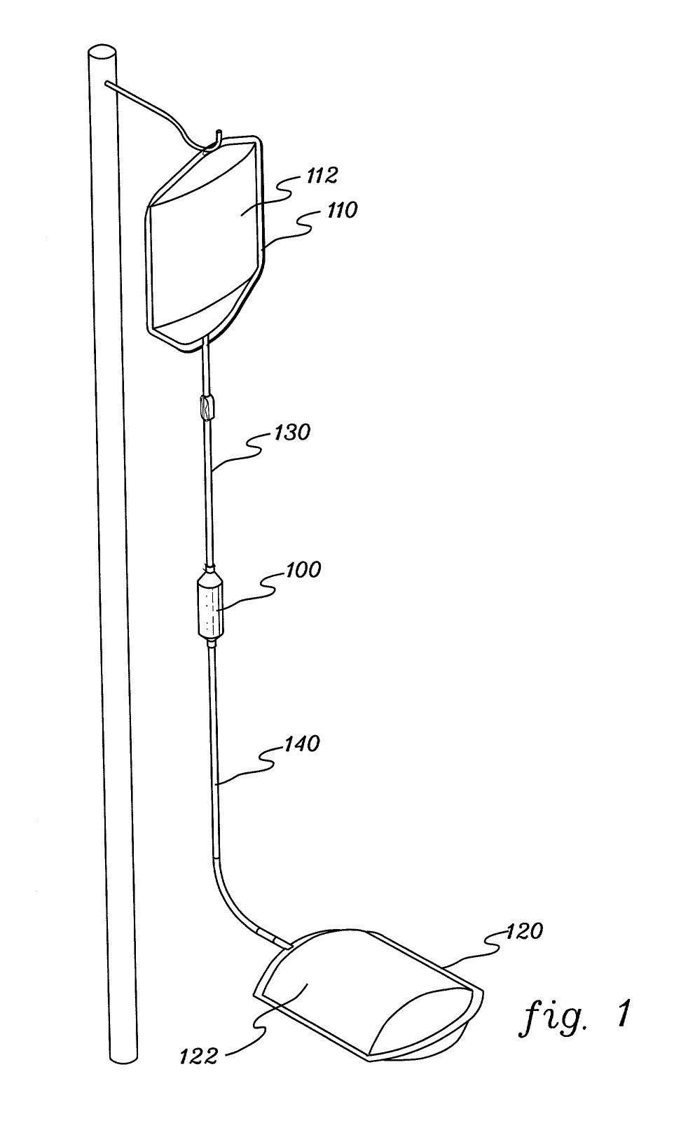

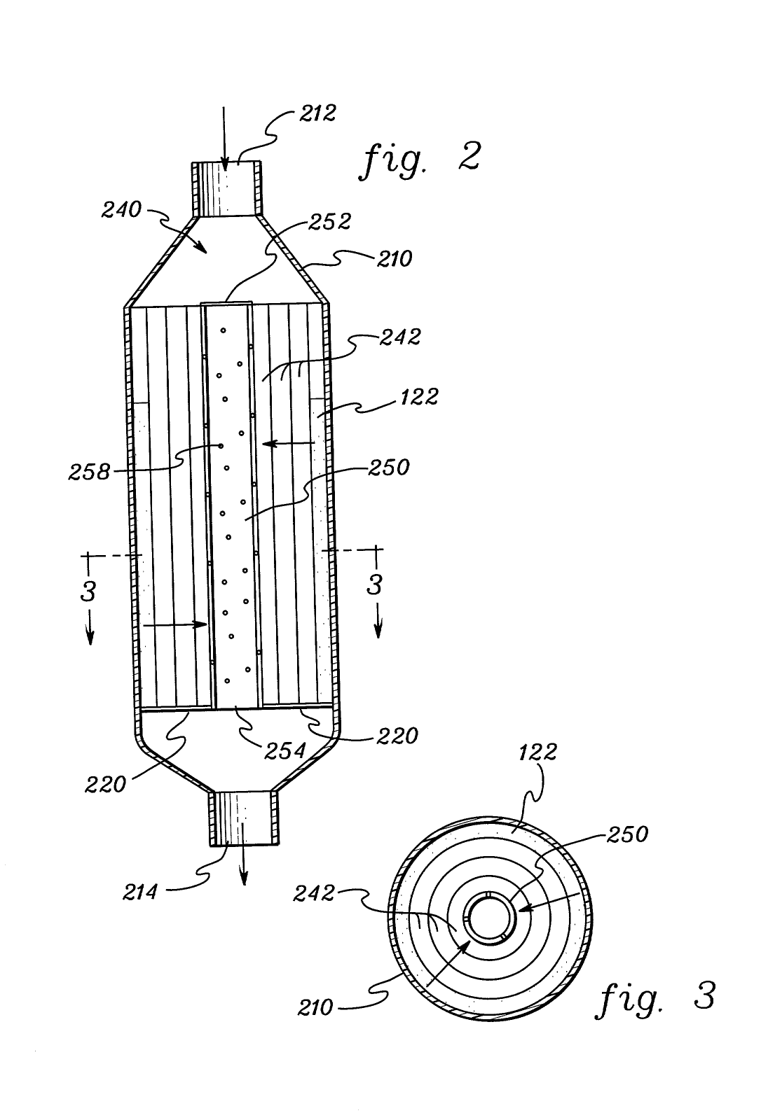

Referring to the figures, e.g., FIG. 1, there is shown an embodiment of the invention comprising a filtration system for the filtration of a biological fluid. The system of the present invention may be used for the filtration of various fluids including biological liquids. However, the system of the present invention is particularly suited for the filtration of blood and/or blood components and thus will be described herein in reference to blood filtration for illustrative purposes.

Preferably, filtration system 10 is a closed in-line filtration system. More preferably, system 10 is also a non-vented system. These preferred conditions are desirable, e.g., to enhance system performance and simplicity and to enhance system sterility. As used herein, the term “in-line” means a system with components pre-connected before use and the system as a whole in a sterile condition once pre-connected and then ready for use. Differently, the term “closed” means a system where an interior of the system (i.e., within the tubings, containers, filter and associated components) is not in communication with an environment external to the system (i.e., the atmosphere surrounding the system). Finally, as used herein, the term “non-vented” means that there are no ports or other openings in the system by which gas can communicate between an interior of the system (i.e., within the tubings, containers, filter and associated components during use of the system) and an environment external to the system (i.e., the atmosphere 100 surrounding the system). Although, in an alternate embodiment, the system may communicate with an external environment.

Returning to FIG. 1, filtration system 10 comprises a filtration assembly 100 interposed between a fluid source 110 of unfiltered fluid 112 and a collection container 120 for recovering filtered fluid 122. In one embodiment, the filtration assembly 100 is in direct communication with the fluid source 110 and the collection container 120. In one embodiment, fluid source 110 may be a living subject, such as a human donor or animal. Biological liquid may be collected directly from source 110, through the filtration assembly 100 and into collection container 120, as in FIG. 1, by simple gravity transfer where the collection assembly 30 is maintained at a height below that of fluid source 110. Preferably, the force of gravity also includes atmospheric pressure, i.e., as exerted on the outside of the walls of housing of the filtration assembly.

The filtration assembly 100 comprises a housing 210 and a filter 240. The housing 210 includes an inlet 212 to receive unfiltered fluid 112 from the fluid source 110 and an outlet 214 to exit filtered liquid 122 from the housing 210 towards the collector 120. The filter 240 is disposed within the housing 212 and serves to separate undesirable substances from the unfiltered fluid 112 entering the housing through the inlet 212.

The housing 210 may be fabricated from any suitably liquid impervious material, including an impervious thermoplastic material. For example, the housing 210 may be fabricated from a transparent polymer, such as an acrylic, polyester, polyvinyl chloride or polycarbonate resin. The transparency of the housing permits observation of the passage of fluid through the housing. In one embodiment, the housing 210 is made from a soft material to allow for collapse of the housing around or against the filter assembly as the fluid is filtered out of the housing in order to minimize the amount of unfiltered liquid remaining within the filtration system after filtration has occurred (also referred to as hold-up). In alternate embodiments, the housing 210 may be made of a rigid housing that does not collapse.

The filter 240 comprises a filter material 242 surrounding a central core 250. In one embodiment, the filter material 242 is wrapped around the central core 250. The filter material 242 is wound around the central core 250 such that additional winds of filter material 242 are comparable to increasing layers of filtration materials as existing in a stacked-up arrangement. In an alternate embodiment, the filter material 242 is packed in the housing 210 around the central core 250. In yet another embodiment, the top portion of the filter, at the same end as the closed end of the central core 250, is sealed such than no unfiltered fluid may bypass the filter, but instead must pass through the filter. With the structural arrangement of the present invention, the filtration assembly 100 provides more surface area for the same dimension of depth of filter material 242 for contacting the unfiltered fluid 112 as compared to prior art filters consisting of stacked-up filtered materials disposed between an inlet and an outlet of a housing. This arrangement also provides more flexibility in the type and amount of filter material used depending on the desired procedure for the filtration of the fluid.

Filter material 242 may include most any conventional filter used for filtering biological fluid and is preferably adapted to filter blood or blood components (e.g., platelets, plasma, red blood cells, white blood cells, or any combination of these and at least concentrated blood cells). Various filter materials are already well known to practitioners in the art. For example, the filter material 242 may include layers of needle punched fabric (e.g. Reemay Grade 5600) to enhance the flow of the fluid to be filtered and filter gel from the fluid; micro-glass, polyvinyl alcohol (PVA) and polyacrylonitrile (PAN) copolymer acrylic pulp combination (e.g. leukocyte filter media manufactured by Whatman International Ltd. in the United Kingdom) for the removal of leukocytes; and/or a thin polyester screen (e.g. Hollytex 3242 manufactured by Reemay of Old Hickory, Tenn. ) and a thin spunbound polybutylene terephthalate polyester screen (e.g. Johns Manville Type 2195-129) for removing fibers or debris. In alternate embodiments, the filter may be made from nylon, acrylics, cellulose acetate or the like, or a combination of these materials depending on the type of filtration desired.

The central core 250 defines a vertical flowpath for the fluid filtered through the filter material 242. In one embodiment, the central core 250 is a longitudinal tube including a first end 252, a second end 254 and side wall 256, or walls depending on the geometry of the core, facing the filter material 242. The first end 252 of the central core 250 projects into the hollow space defined by the housing 210 and is sealed, closed or capped to prevent the entry of unfiltered fluid 112 from bypassing the filter material 242. The second end 254 of the central core 250 communicates with the outlet 214 of the housing 210 and permits filtered fluid 122 to exit the housing 210.

Unfiltered fluid 112 enters through the inlet 212 at the top of the housing 210, passes through the filter 242, travels down the vertical flow path defined by the central core 250 and exits through the outlet 214 of the housing 210. Unfiltered fluid 112 is prevented from bypassing the filter 240 and passing directly through the housing 210 by an impervious barrier, seal or shield 220 located in proximity to the outlet 214 of the housing 210 and extending radially inward from the inside surface of the housing 210 to central core 250. The barrier, seal or shield 220 may be heat sealed or otherwise bonded to the inside surface of the housing 210. The barrier, seal or shield 220 also serves to seal the filter material layers surrounding the central core 250. In alternate embodiments, the second end 248 of central core 250 extends into or through the outlet 214 of the housing 210 effectively creating a seal that prevents unfiltered fluid 112 from exiting the housing.

The unfiltered fluid flows inwardly through the filter material 242 towards the central core 250 by the pressure of gravity. The unfiltered fluid passes through pores or holes 258 defined in the side wall 256 of the central core 250. After passing through these pores or holes 258, the filtered fluid 112 falls, drips or runs downwardly by the force of gravity towards the second end 254 of the central core 250 and outlet 214 of the housing 210. The central core 250 can be made from, for example, a polymer which is injection molded and is, preferably, not sintered. In alternate embodiments, the central core 250 can be flattened and expanded in one plane to make it more like a hollow housing around which the filter is sealed.

In constructing the filtration assembly 100, the central core 250 may be loaded onto a mandrel while filter material 242 is wrapped around the central core 250. Also, during construction, long lengths of material can be wrapped with filter material and subsequently cut, with one end being capped off, and installed into a plurality of filtration housings. The filter assembly 240 and housing 210 can be assembled using radio frequency which eliminates the need for the use of adhesives.

As illustrated in FIG. 1, fluid source 110 connects to the inlet 212 of the housing 210 of the filtration assembly 100 by an inlet tubing 130 and the collection container 120 connects to the outlet 214 of the housing 210 of the filtration assembly 100 by outlet tubing 140. All tubings 130, 140 connecting the filtration assembly 100 with the fluid source 110 and collection container 120 may be made of any medical grade plastic-type tubing or the like that is, preferably, flexible and semi-rigid.

The fluid source 110 and collection container 120 may include containers made of any medical grade container material, such as, for example, a plastic-type or the like material, that is, preferably, flexible and not rigid and adapted for longer term storage of biological fluids such as, for example, blood or blood components and capable of withstanding a centrifugation and sterilization environment. For example, blood collection and satellite bags are typically made from plasticized polyvinyl chloride, e.g., PVC plasticized with dioctylphthalated diethylhexylphthalate or triocytyltrimelliate. The bags may also be formed from polyolefin, polyurethane, polyester, polycarbonate or the like. Preferably, all of the tubings and containers of system are either formed integrally with each other or are connected in a secure and sterile manner, using conventional means and methods. The containers can be easily removed when they ares no longer needed without compromising any other portions of system 10.

In alternate embodiments, the filtration system may include other in-line components such as, for example, additional containers supplying other fluids to the system (e.g. saline), gas inlets and outlets, clamps to regulate the flow of fluids or gases, and an air container for holding air displaced from the system.

In operation, unfiltered fluid 112 flows into the inlet 212 of the housing 210 of the filtration assembly 100 from the fluid source 110 through the inlet tubing 130. As the unfiltered fluid 112 enters the housing 210, the unfiltered fluid 112 flows to and accumulates on the bottom of the housing 210, on top of the impervious seal 220. In an alternate embodiment, the fluid may be manifolded or baffled to distribute the flow of unfiltered fluid more evenly around the filter material to prevent an overload of unfiltered fluid near the second end 254 of the central core 250 or bottom of the housing 210.

Under the pressure of gravity, the unfiltered fluid 112 passes through the filter 242 where, depending on the type of filter material used, undesired substances in the unfiltered fluid 112, such as, for example, debris, fibers, leukocytes, gels or the like, are removed.

After the fluid passes through the filter, the filtered fluid passes through the pores or holes 258 defined in the side wall 256 of central core 250. As the fluid drains through the filter, the soft housing 210 collapses around the filter 242 to aid in the removal of fluid from the housing and to minimize upstream hold-up of unfiltered fluid. The filtered blood 122 then flows down the pathway defined by the central core 250, by the force of gravity, i.e., by suspending the filtration assembly 100 above the collection container 120, towards the outlet 214 of the housing 210 of the filtration assembly 100, through the outlet tubing 140 and into the collection container 120.

As various possible embodiments may be made in the above invention for use for different purposes and as various changes might be made in the embodiments above set forth, it is understood that all of the above matters here set forth or shown in the accompanying drawings are to be interpreted as illustrative and not in a limiting sense. It will be further apparent to one of ordinary skill in the art that said various modifications may be made to the embodiments without departing from the scope of the invention as defined in the following claims.

What is claimed is:

1. A filtration device comprising:
a housing, said housing including an inlet for receiving unfiltered fluid and an outlet for exiting filtered fluid;
a core disposed within said housing, said core defining a flow path for delivering filtered fluid to the outlet of said housing, said core including a closed first end projecting into said housing and a second end communicating with the outlet of said housing; and
a filter surrounding said core, said filter being capable of filtering the unfiltered fluid entering the inlet of said housing, wherein said core receives the filtered fluid passing through said filter.

2. The filtration device of claim 1, wherein said housing includes means for preventing unfiltered fluid from exiting the outlet of said housing.

3. The filtration device of claim 2, wherein the preventing means is an impervious barrier extending radially from an inner surface of said housing to said core.

4. The filtration device of claim 1, wherein said housing is collapsible around said filter as the unfiltered fluid exits said housing.

5. The filtration device of claim 1, wherein said filter is wrapped around said core.

6. The filtration device of claim 5, wherein a plurality of layers of filter material are wrapped around said core.

7. The filtration device of claim 1, wherein said core includes a plurality of pores for receiving the filtered fluid from said filter.

8. A method for filtering fluid comprising:
directing unfiltered fluid through an inlet of a housing;
filtering the unfiltered fluid through a filter towards a core disposed within the housing, said filter surrounds the core;
passing the filtered fluid through the central core; and
directing the filtered fluid out of an outlet of the housing.

9. A filtration system comprising:
a supply source of unfiltered fluid;
a collection container of filtered fluid;
a filtration device comprising a housing and a filtration assembly disposed within the housing, the housing including an inlet for receiving unfiltered fluid from said supply source and an outlet for exiting filtered fluid to said collection container, the filtration assembly including a filter surrounding a core, the core receiving filtered fluid from the filter and delivering the filtered fluid to the outlet of the housing.
